(19) United States
(12) Patent Application Publication
(10) Pub. No.: US 2011/0222115 A1
(43) Pub. Date: Sep. 15, 2011

(54) IMAGE FORMING APPARATUS, IMAGE FORMING SYSTEM, PRINTING INSTRUCTION APPARATUS, COMPUTER READABLE RECORDING MEDIUM STORED WITH A PROGRAM FOR IMAGE FORMING APPARATUS OR PRINTING INSTRUCTION APPARATUS, AND IMAGE FORMING METHOD

(75) Inventor: Kazuto Yamamoto, Koganei-shi (JP)

(73) Assignee: KONICA MINOLTA BUSINESS TECHNOLOGIES, INC., Chiyoda-ku (JP)

(21) Appl. No.: 13/038,436

(22) Filed: Mar. 2, 2011

(30) Foreign Application Priority Data
Mar. 9, 2010 (JP) 2010-052129

(51) Int. Cl. G06F 15/00

(52) U.S. Cl. 358/1.15

(57) ABSTRACT

The image forming apparatus comprising a judgment unit for judging whether an instruction for preparing a carbon copy exists or not, and a print data preparation unit for preparing a plurality of print data based on a single document data when the judgment unit determines that an instruction for preparing the carbon copy exists.

### CROSS-REFERENCE TO RELATED APPLICATION

This application is based on Japanese Patent Application No. 2010-052129, filed on Mar. 9, 2010, the contents of which are incorporated herein by reference.

### BACKGROUND

1. Technical Field

The present invention relates to an image forming apparatus, an image forming system, a printing instruction apparatus, a recording medium stored with a program for the image forming apparatus or the printing instruction apparatus, and an image forming method.

2. Description of Related Art

It has been a custom in generating a transaction slip to be used in a transaction with a client to print the first sheet of the transaction slip on a sheet of better quality paper, while printing the second sheet for processing purpose and third sheet used for filing purpose with the carbon copy function of a printer.

This has resulted accordingly in the waste of paper and developing agent as a filing copy is printed even when it is not necessarily needed. On the other hand, storing the filing copy as electronic data makes the process cumbersome, therefore it has been difficult to store the filing copy as electronic data in a simple manner.

As a technology of reducing the consumption of the developing agent in the process of printing the filing copy, a method is disclosed in the Unexamined Japanese Patent Publication No. 2007-237644 in which filing copies are printed in monochromatic.

However, although the aforementioned prior art is capable of reducing the consumption of the developing agent, it cannot reduce paper consumption.

### SUMMARY

The present invention is made to solve such a problem and intends to provide a means of generating carbon copies simply and inexpensively.

To achieve at least one of the aforementioned objects, an image forming apparatus reflecting one aspect of the present invention comprising: a judgment unit for judging whether an instruction for generating a carbon copy exist or not; and a print data generation unit for generating a plurality of print data based on a single document data when said judgment unit determines that said instruction for generating said carbon copy exists.

It is preferable that the aforementioned image forming apparatus further comprising: a serial number adding unit for adding a serial number to at least one of the plurality of print data generated by the print data preparation unit.

It is preferable that the aforementioned image forming apparatus further comprising: a print data fabrication unit for either one of fabrications of adding texts, masking a portion of the print data, or modifying the print data's background on at least one of the plurality of print data generated by the print data generation unit.

It is preferable that the aforementioned image forming apparatus further comprising: a print data for filing transmission unit for transmitting print data for carbon copy selected for a filing use from the plurality of print data using a network protocol to a server.

It is preferable that the aforementioned image forming apparatus further comprising: a printing unit for printing on printing paper the print data other than said print data for carbon copy among the plurality of print data.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the constitution of an imaging forming apparatus according to the first embodiment of the present invention.

FIG. 2 is an explanatory diagram showing the image forming apparatus according to the first embodiment of the present invention, a printing instruction apparatus and a server connected to the image forming apparatus via a network.

FIG. 3 is a flowchart showing a program for the image forming apparatus and an image forming method according to the first embodiment of the present invention.

FIG. 4 is a diagram showing an example of generated document print data and carbon copy print data.

FIG. 5 is a diagram showing carbon copy setting information included in a print job transmitted from the printing instruction apparatus to the image forming apparatus.

FIG. 6 is a diagram showing an example of a setup screen on a printer driver for setting up a carbon copy included in a print job to be transmitted to the image forming apparatus from the printing instruction apparatus.

FIG. 7 is a diagram showing an example of an editing screen for editing the carbon copy print data.

FIG. 8 is an explanatory diagram showing the printing instruction apparatus according to the second embodiment of the present invention, the image forming apparatus and the server connected to the printing instruction apparatus via a network.

FIG. 9 is a flowchart showing a program for the printing instruction apparatus and the image forming method according to the second embodiment of the present invention.

### DETAILED DESCRIPTION

An image forming apparatus, an image forming system, a printing instruction apparatus, a computer readable recording medium stored with a program for the image forming apparatus or the printing instruction apparatus, and an image forming method according to embodiments of this invention will be described below with reference to the accompanying drawings.

The “print data” mentioned in this specification includes not only data for printing on printing paper (sheet) but also, for example, data for displaying (printing) texts and graphics on a display.

The image forming apparatus, the image forming system, the recording medium stored with the program for the image forming apparatus, and the image forming method according to the first embodiment of this invention will be described.

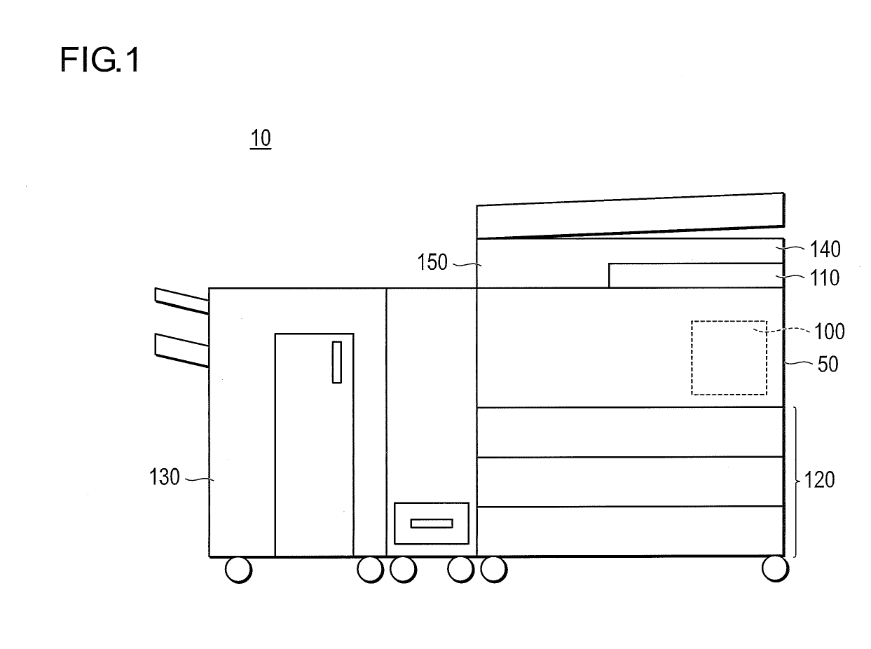

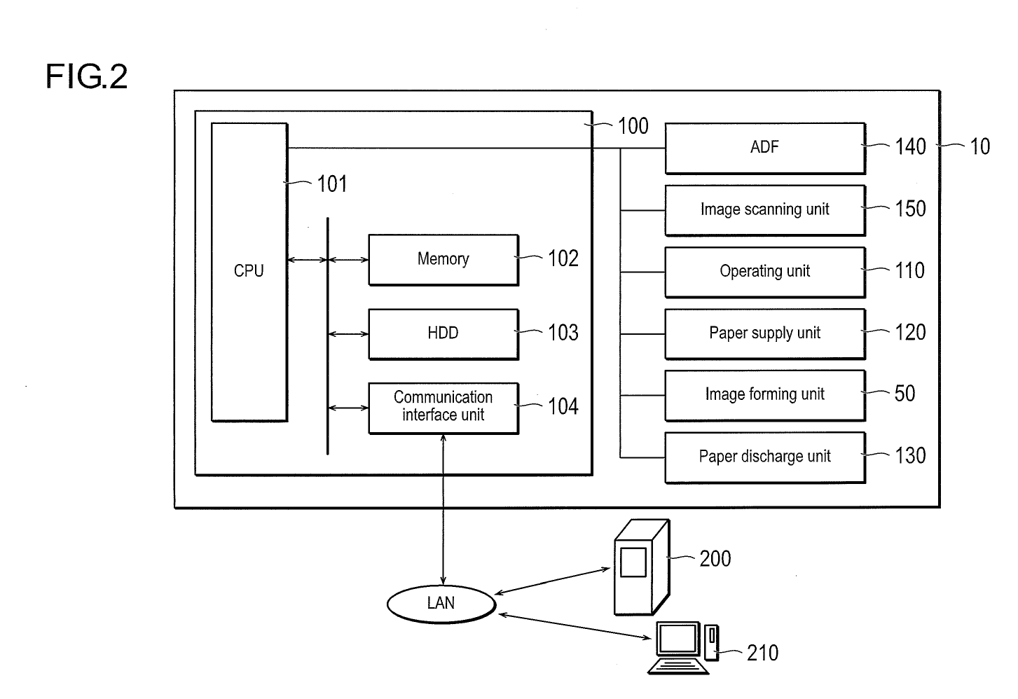

FIG. 1 is a diagram showing the constitution of the imaging forming apparatus according to the first embodiment of the present invention. FIG. 2 is an explanatory diagram showing the image forming apparatus according to the present embodiment, the printing instruction apparatus and a server connected to the image forming apparatus via a network. The image forming system according to the present embodiment comprises the image forming apparatus and the printing instruction apparatus.

The image forming apparatus 10 according to the present embodiment comprises a control unit 100, an image forming unit 50, an operating unit 110, a paper supply unit 120, and a paper discharge unit 130. The image forming apparatus 10 according to the present embodiment may have in addition an ADF (Auto Document Feeder) 140, or an image scanning unit 150. The image forming apparatus 10 according to the present embodiment may consist of an MFP (Multi-Function Peripheral).

The control unit 100 comprises CPU (Central Processing Unit, a judgment unit, a print data generation unit, a serial number adding unit, and a print data fabrication unit) 101, a memory (the judgment unit, the print data generation unit, the serial number adding unit, and the print data fabrication unit) 102, HDD (Hard Disk Drive, the judgment unit, the print data generation unit, the serial number adding unit, and the print data fabrication unit) 103, and a communication interface unit (a reception unit, and a print data for filing transmission unit) 104, and these constituent elements are mutually connected via a bus.

The CPU 101 is a device for controlling various constituent elements of the image forming apparatus 10 and executes various computations (e.g., image processing) by means of the program.

The memory 102 is a main storage device for storing programs and data temporarily. The memory 102 stores the data input via the communication interface unit 104, the data retrieved from the HDD 103, or the data scanned by the image scanning unit 150. The data stored in the memory 102 is retrieved by the CPU 101 and processed as needed. The memory 102 may be constituted, for example, of DRAM (Dynamic Random Access Memory).

The HDD 103 is an auxiliary storage device for storing programs and data by means of magnetic recording. The HDD 103 stores the program for the CPU 101 to control various constituent elements of the image forming apparatus 10. It also stores data patterns used for the carbon copies. The data stored in the HDD 103 is retrieved onto the memory 102 by the CPU 101 as needed and is processed on the memory 102.

The communication interface unit 104 is an input/output device for transmitting and receiving data between the server 200 and the printing instruction apparatus (transmission unit) 210 as a client, via an LAN (Local Area Network). In other words, the communication interface unit 104 executes data transmission and reception using various network protocols establishing a connection with the server 200 and the printing instruction apparatus 210.

The image forming unit (printing unit) 50 comprises constituent elements necessary for forming images on the printing paper in the image forming apparatus 10. In other words, the image forming unit 50 includes, for example, a sensitizing member, a transfer belt, a fixing member, various transportation belt, and a both side execution unit. The image forming unit 50 prints the image data (bitmap data) which is rasterized in the control unit 100 as an image on the printing paper, and send the printed paper to the paper discharge unit 130.

The operating unit 110 is a device for a user to execute various settings for the paper stored in the paper supply unit 120.

The paper supply unit 120 is a device for storing the printing paper and feeding the stored printing paper to the image forming unit 50.

The paper discharge unit 130 is a device for discharging the printed printing paper.

The ADF 140 is a device for automatically transporting a single document sheet or a plurality of document sheets of original document sheets (document data) to the image scanning unit 150.

The image scanning unit 150 is a device for optically scanning the image data from the original document sheet on a document table.

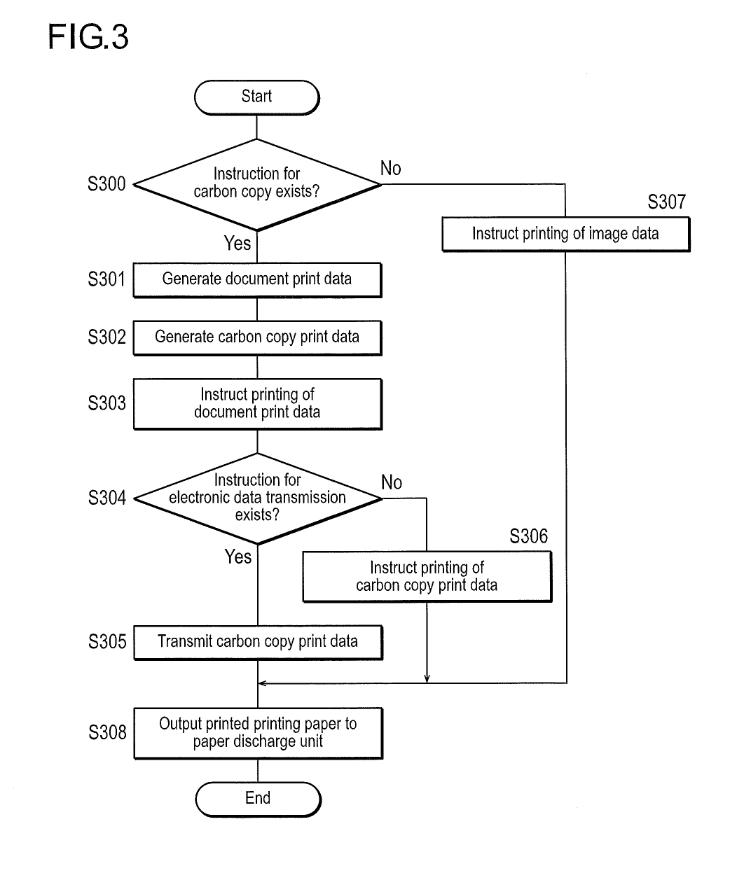

FIG. 3 is a flowchart showing the program for the image forming apparatus and the image forming method according to the present invention. The program for the image forming apparatus and the image forming method according to the present embodiment can be executed by the image forming apparatus or the image forming system according to the present embodiment shown in FIG. 2.

The program for the image forming apparatus and the image forming method according to the present embodiment is described showing the number of each step of the flowchart shown in FIG. 3.

The image forming apparatus 10 stands by until it receives a print job from the printing instruction apparatus 210; and when a print job is received at the printing cue, the control unit 100 judges whether there is any instruction for carbon copy (i.e., an instruction for generating the carbon copy) (S300). In other words, the control unit 100 judges whether the communication interface unit 104 has received an instruction for generating the carbon copy.

If there is no instruction for the carbon copy (S300: No), the control unit 100 instructs the image forming unit 50 to print the document data included in the print job on printing paper (S307). The document data means image data which becomes the basis of the print data which is printable. The print data includes a document print data and a carbon copy print data, which will be described later.

The image forming unit 50 prints the image data on the printing paper supplied by the paper supply unit 120, and outputs it to the paper discharge unit 130 after post-processing (e.g., punching, stapling, and binding) the printed printing paper (S308). As an alternative, for example, the document data may be converted to the document print data to save it in the HDD 103 as electronic data or to save it in the server 200 via the network instead of printing the document data on the printing paper. By saving the document data as electronic data, it is possible to reduce the consumption of the printing paper and developing agent. The document print data here means the document data converted to printable data.

If instruction for carbon copy exists (S300: Yes), the document print data is generated (S301). A fabrication such as adding necessary information such as a serial number, or masking unnecessary data, may be executed, while generating the document print data.

Also, the carbon copy print data is generated based on the document data (S302). The carbon copy print data here means the carbon copy of the document data converted to printable data. A fabrication such as adding a text or masking an unnecessary portion or modify a background may be executed, while generating the carbon copy print data. For example, adding a serial number or a text of “File Copy,” or masking a telephone number, or changing a background color, may be executed.

It goes without saying that, as the carbon copy print data, any carbon copy print data that is necessary may be generated in addition to the print data for the client and the print data for filing. Although the carbon copy data generated based on single document data is normally more than one, it can be only one.

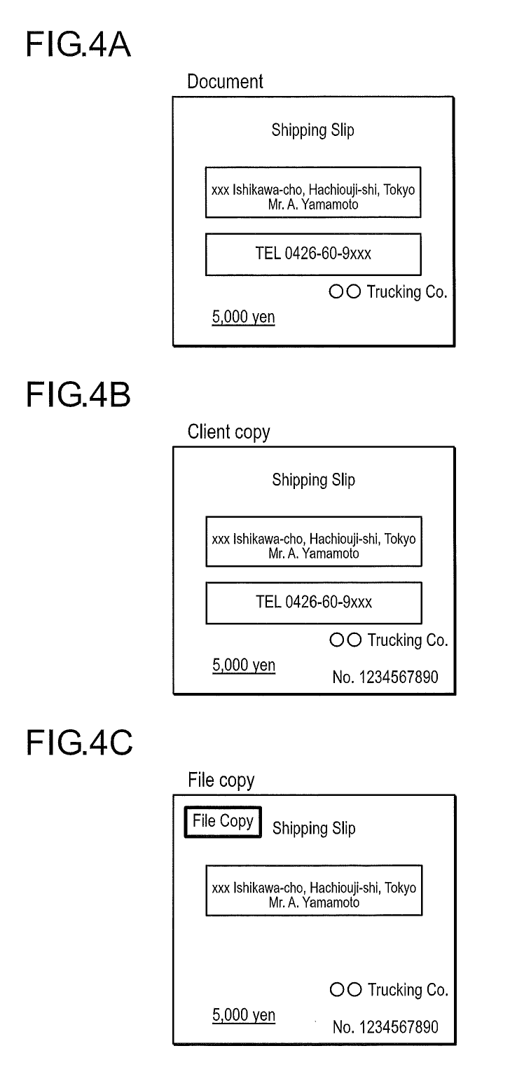

FIG. 4 is a diagram showing an example of generated document print data and the carbon copy print data. The A of FIG. 4 is an example of the document print data. The B and the C of FIG. 4 are examples of the carbon copy print data; more specifically, the B of FIG. 4 is the carbon copy print data for the client, while the C is the carbon copy print data for filing (print data for carbon copy).

As shown on FIG. 4, the carbon copy print data for the client is fabricated in such a way that a serial number is added to the document data. On the other hand, the carbon copy print data for filing is fabricated in such a way that the serial number and a text of “File Copy” are added and the telephone number is masked.

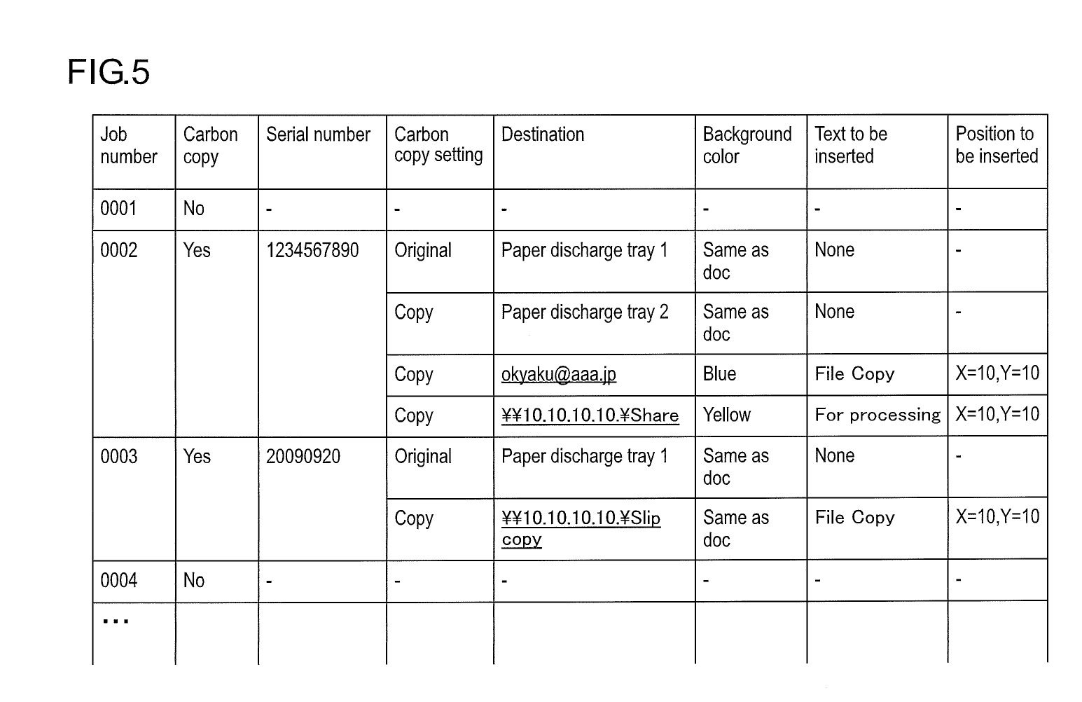

FIG. 5 is a diagram showing carbon copy setting information included in the print job transmitted from the printing instruction apparatus 210 to the image forming apparatus 10.

As we focus our attention on the job number 0002 of FIG. 5, we see that there is the instruction for generating carbon copies (carbon copy: Yes), more specifically, carbon copy data for three pieces of carbon copies (carbon copy setting: Copy). As being instructed that one of the three pieces of the carbon copy print data is to be added “1234567890” as the serial number (serial number: 1234567890) and to be transmitted it to the paper discharge tray 2 (destination: paper discharge tray 2), the instruction causes the carbon copy print data of the B of FIG. 4 to be generated, printed on the printing paper, and outputted to the paper discharge tray 2. Another one of the three pieces of the carbon copy print data is instructed to be added “1234567890” as the serial number (serial number: 1234567890), to be modified the background color to blue (background color: Blue), and to be added a text of “File Copy” (inserted text: File Copy) to the position for adding (insertion position: X=10, Y=10). As it also designates a specific domain name as the destination (destination: okyaku@aaa.jp). Following the instruction, the carbon copy print data such as the C of FIG. 4 is generated and is transmitted as electronic data to the computer having a designated domain name (e.g., server 200). While the telephone number is masked in the document data in case of the carbon copy print data of the C of FIG. 4, it is allowed in a portion of the masking of the carbon copy print data, for example, to specify the masking position in the setting information to be transmitted from the printing instruction apparatus 210 to the image forming apparatus 10 and to add a color same as that of the background to said specified position.

As described above, the consumption of the printing paper and the developing agent can be reduced by saving the carbon copy print data as electronic data without printing it on the printing paper. Also, by including the setting of the carbon copy print data in the print job, it is possible to generate the carbon copy print data as electronic data in a simple manner and transmit the carbon copy print data immediately to the destination the user wishes.

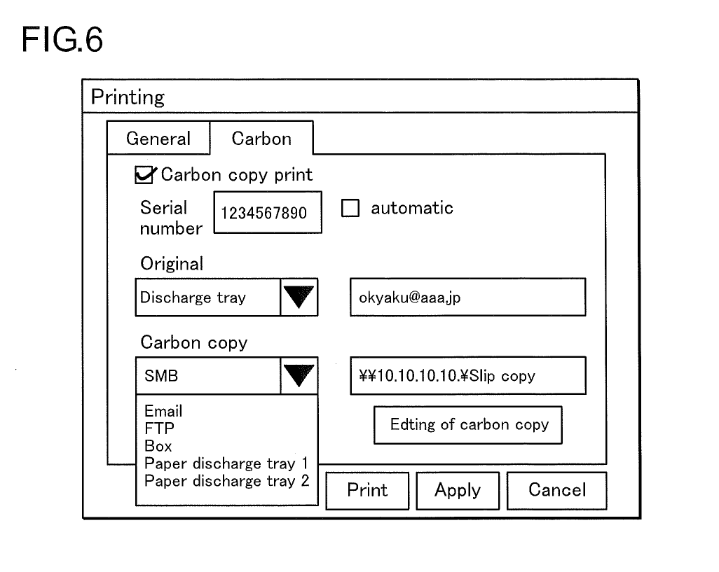

FIG. 6 is a diagram showing an example of the setup screen on the printer driver of the printing instruction apparatus 210 for setting up a carbon copy for a print job to be transmitted to the image forming apparatus 10 from the printing instruction apparatus 210. The contents of the carbon copy print data and the document print data edited on the setup screen shown in FIG. 6 will be reflected on the setting of the carbon copy in the print job.

As shown in FIG. 6, the setting of the carbon copy can be done by checking a check box of the carbon copy print on the setting screen of the printer driver of the printing instruction apparatus 210. Also, it is possible to designate the serial number, designate the paper discharge tray (paper discharge unit 130) when printing the original document data (original), and designate the destination or saving location as well as the transmission protocol of the carbon copy print data. Moreover, an editing screen may be provided for editing (fabricating) the carbon copy print data in accordance with the use of the carbon copy.

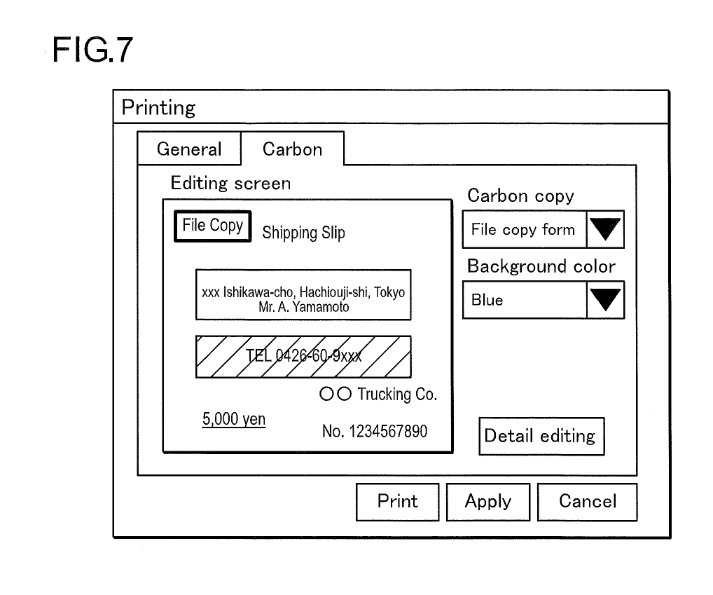

FIG. 7 is a diagram showing an editing (fabricating) screen for editing the carbon copy print data. The contents of the carbon copy print data edited on the editing screen shown in FIG. 7 will be reflected on the setting of the carbon copy in the print job.

For example, as shown in FIG. 7, on the carbon copy print data for filing, the setting (carbon copy: file copy form) of the data pattern (format) and the setting of the background color (background color: blue) can be done through the selection of the pull-down menu. Also, the carbon copy print data can be edited by adding or deleting texts by displaying the carbon copy print data on the editing screen.

Next, the control unit 100 instructs the image forming unit 50 to print the document print data (S303). However, the document print data may be, for example, transmitted from the communication interface unit 104 to the server 200 as electronic data and be saved in the server 200 as electronic data without being printed on the printing paper. The document print data can be saved in the HDD 103.

The control unit 100 judges whether there is an instruction for electronic data transmission of the carbon copy print data in the print job (S304). The carbon copy print data for which an electronic data transmission is designated here may be print data for filing which is print data selected for filing. For example, the selection of the carbon copy print data for filing can be done by adding an instruction for selecting the carbon copy print data for filing in the print job, or by setting the transmission address of the carbon copy print data in the server 200 as an alternative.

If there is no instruction for electronic data transmission (S304: No), the control unit 100 instructs the image forming unit 50 to print the carbon copy print data on the printing paper (S306). If an instruction for electronic data transmission exists (S304: Yes), the carbon copy print data is transmitted to the destination designated (e.g., server 200) from the communication interface unit 104 (S305). The transmission of the carbon copy printing data to the designated destination may be done using a generally known network protocol such as FTP (File Transfer Protocol), SMB (Server Message Block), and Email for example. However, the carbon copy print data may be saved in the box formed in the HDD 103 of the image forming apparatus 10 without being transmitted via the network. Also, if there exists a plurality of pages of carbon copy data, those pages may be addressed to different addresses. Moreover, a portion of the plurality of pages of the carbon copy print data may be printed on the printing paper while transmitting the remaining carbon copy print data to the designated address as electronic data.

In case of the job number 0002 shown in FIG. 5, since the paper discharge tray 2 is designated as the destination indicating that electronic data transmission is not designated for the carbon copy print data, the particular carbon copy print data is printed on printing paper, and is output as a printed matter from the discharge tray 2 after it is post-processed. On the other hand, if a domain name (e.g., okyaku@aaa.jp) is designated as destination, the carbon copy print data is transmitted to a computer (e.g., the server 200) designated by the domain name in order to indicate that electronic data transmission is designated for the carbon copy print data. Since it means that there is an instruction for transmitting the electronic data of the carbon copy print data in case when the directory of a recording media (e.g., ¥¥10.10.10.10¥share) is designated as the destination, the particular carbon copy print data is transmitted (saved) to the designated directory (e.g., a directory of HDD 103).

The image forming unit 50 outputs the printing paper printed the document print data and the carbon copy print data on to the paper discharge unit 130 after the post-processing (S308).

While the above is the description of the image forming apparatus, the image forming system, the program for the image forming apparatus, and the image forming method according to the first embodiment, it is possible to generate a carbon copy easily and economically.

The printing instruction apparatus, the recording medium stored with the program for the printing instruction apparatus, and the image forming method according to the second embodiment of this invention will be described. The descriptions that overlap with those in the first embodiment will be omitted.

The difference between the present embodiment and the first embodiment is that the image forming apparatus generates the carbon copy print data based on the document data in the first embodiment, while the printing instruction apparatus generates the carbon copy print data based on the document data in the present embodiment.

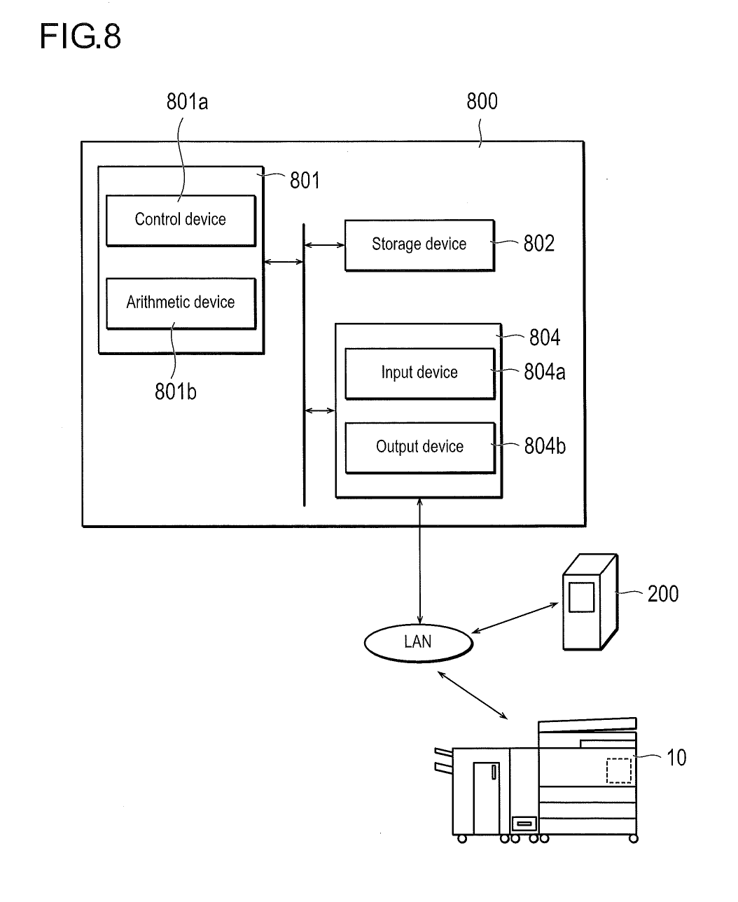

FIG. 8 is an explanatory diagram showing the printing instruction apparatus according to the present embodiment, and the image forming apparatus and the server connected to the printing instruction apparatus via a network.

The printing instruction apparatus 800 according to the present embodiment comprises a control device (the print data generation unit, the serial number adding unit, and the print data fabrication unit) 801a, an arithmetic device (the print data generation unit, the serial number adding unit, and the print data fabrication unit) 801b. a storage device (the print data generation unit, the serial number adding unit, and the print data fabrication unit) 802, an input device (an input unit) 804a, and an output device (a print data for filing transmission unit) 804b. In other words, the printing instruction apparatus 800 according to the present embodiment can be constituted using a common computer.

The control device 801a and the arithmetic device 801b constitute the arithmetic and control unit 801. The arithmetic and control unit 801 may be constituted using the CPU. The arithmetic and control unit 801 controls various constituent elements of the printing instruction apparatus 800 and executes various computations such as image processing based on the program.

The storage device 802 consists of a main storage device and an auxiliary storage device. The main storage device can be constituted using, for example, the DRAM. The auxiliary storage device can be constituted using, for example, the HDD. The main storage device that constitutes the storage device 802 stores data entered via the input device 804a and data retrieved from the auxiliary storage device. The data stored in the main storage device is retrieved by the control device 801a as needed and is processed by the arithmetic device 801b.

The auxiliary storage device that constitutes the storage device 802 is stored with the program for the control device 801a to control various constituent elements of the printing instruction apparatus 800. It also stores data patterns used for the carbon copies. The data stored in the auxiliary storage device is retrieved onto the main storage device by the control device 801a as needed and is processed on the main storage device.

The input device 804a and the output device 804b constitute the input/output device 804. The input/output device 804 executes the transmission and reception of the data with the server 200 and the image forming apparatus 10 via a LAN. In other words, the input/output device 804 executes data transmission and reception using various network protocols establishing connections with the server 200 and the image forming apparatus 10. Also, an instruction for generating a carbon copy is entered in the input device 804a that constitutes the input/output device 804.

The input/output device 804 may comprise a network card for connecting the printing instruction apparatus 800 to the LAN, a keyboard to be used for entering an instruction for generating the carbon copy, and a display to be used for visually check and fabricate the carbon copy print data. The printing instruction apparatus 800 is connected to the image forming apparatus (printing unit) 10 and the server 200 by the input/output device 804.

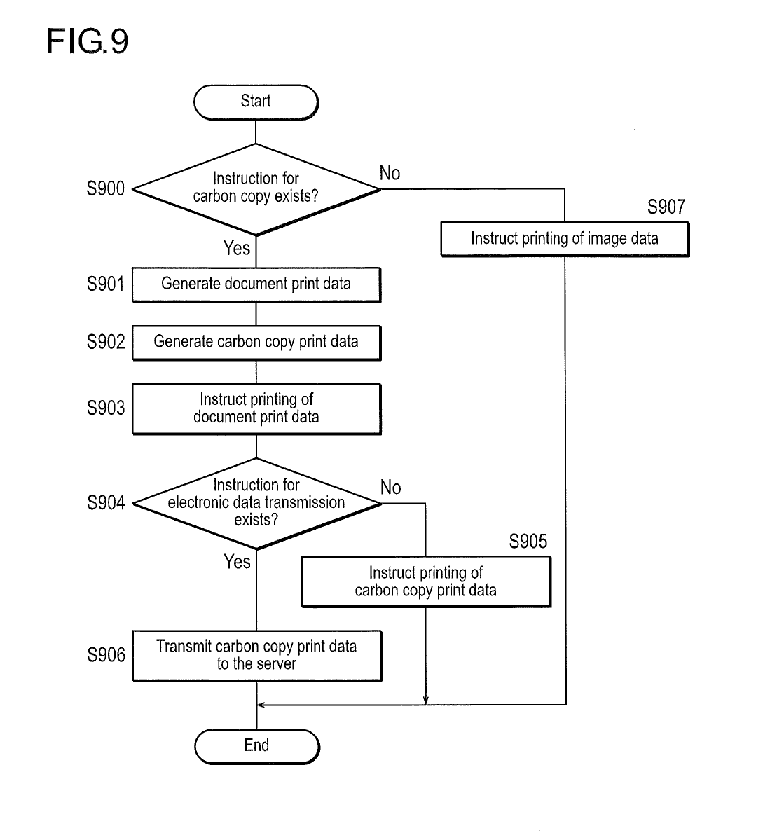

FIG. 9 is a flowchart showing a program for the printing instruction apparatus and the image forming method according to the present invention. The image forming method according to the present embodiment can be executed using the printing instruction apparatus according to the present embodiment.

The program for the printing instruction apparatus and the image forming method according to the present embodiment will be described showing the number of each step of the flowchart shown in FIG. 9.

As the printing instruction apparatus 800 receives an input of a print job containing the instruction for generating the carbon copy from the input device 804a on the printer driver, the arithmetic and control unit 801 judges whether there is any instruction for the carbon copy on the received print job (S900).

If there is no instruction for the carbon copy (S900: No), the arithmetic and control unit 801 instructs the image forming unit 10 to print the image data (document data) included in the print job on printing paper (S907). The arithmetic and control unit 801 may, instead of instructing the image forming apparatus 10 to print the document data on printing paper, as an alternative, convert the document data to document print data, store it in the storage device 802 as electronic data, or store it on the server 200, via the network.

If the designation for the carbon copy exists (S900: Yes), the document print data is generated (S901). A fabrication such as adding necessary information such as the serial number, or masking unnecessary data, may be done, while generating the document print data.

Also, the printing instruction apparatus 800 generates the carbon copy print data (print data) based on the document data (S902). The fabrication such as adding text, or masking the unnecessary portion, or modify the background color, may be executed, while generating the carbon copy print data. For example, adding the serial number or the text of “File Copy,” or masking the telephone number, or changing the background color, may be executed.

It goes without saying that, as the carbon copy print data, any carbon copy print data that is necessary may be generated in addition to the print data for the client and the print data for filing. Although the carbon copy data generated based on single document data is normally more than one, it may be only one.

Next, the arithmetic and control unit 801 instructs the image forming apparatus 10 to print the document print data (S903). However, the document print data may be, for example, transmitted from the input/output device 804 to the server 200 as electronic data and be saved in the server 200 as electronic data without being printed on the printing paper. The document print data may be saved in the storage device 802.

The arithmetic and control unit 801 judges whether the instruction for electronic data transmission of the carbon copy print data exists in the print job (S904). If there is no instruction for electronic data transmission (S904: No), the arithmetic and control unit 801 transmits the instruction to the image forming apparatus 10 to print the carbon copy print data on the printing paper (S905). If there is the instruction for electronic data transmission (S904: Yes), the carbon copy print data is transmitted to the destination designated (e.g., server 200) from the input/output device 804 (S906). The transmission of the carbon copy print date to the designated destination can be done using a generally known network protocol such as FTP, SMB, and Email for example. However, the carbon copy print data may be saved in the box formed in the storage device 802 in the image forming apparatus 800 without being transmitted via the network. Also, if there exists a plurality of pages of carbon copy data, those pages may be addressed to different addresses. Moreover, a portion of the plurality of pages of carbon copy print data may be printed on the printing paper while transmitting the remaining carbon copy print data to the designated address as electronic data.

While the above is the description of the printing instruction apparatus, the program for the printing instruction apparatus, and the image forming method according to the second embodiment of the present invention, it is possible to generate a carbon copy easily and economically according to this embodiment.

Although the present invention is described referring to the embodiments in the above, the present invention shall not be construed in any way to be restricted by the above embodiments.

For example, although the instruction for generating the carbon copy to be transmitted from the printing instruction apparatus to the image forming apparatus in the first embodiment, it may be constituted in such a way as to enter the instruction for generating the carbon copy from the operating unit of the image forming apparatus.

Also, the sequence of the steps S301 through S303 in the first embodiment is not restricted to the order shown. Those steps in fact may be executed in parallel. The same thing may be applied to the steps S901 through S903 of the second embodiment.

What is claimed is:

1. An image forming apparatus, comprising:
a judgment unit for judging whether an instruction for generating a carbon copy exist or not; and
a print data generation unit for generating a plurality of print data based on single document data when said judgment unit determines that said instruction for generating said carbon copy exists.

2. The image forming apparatus as claimed in claim 1 further comprising:
a serial number adding unit for adding a serial number to at least one of said plurality of print data generated by said print data generation unit.

3. The image forming apparatus as claimed in claim 1 further comprising:
a print data fabrication unit for at least one of fabrications of adding texts, masking a portion of said print data, or modifying said print data's background on at least one of said plurality of print data generated by said print data generation unit.

4. The image forming apparatus as claimed in claim 1 further comprising:
a print data for filing transmission unit for transmitting print data for carbon copy selected for filing from said plurality of print data using a network protocol to a server.

5. The image forming apparatus as claimed in claim 4 further comprising:
a printing unit for printing on printing paper said print data other than said print data for carbon copy among said plurality of print data.

6. An image forming system, comprising:
a transmission unit for transmitting an instruction for generating a carbon copy;
a reception unit for receiving said instruction for generating the carbon copy from said transmission unit; and
a print data generation unit for generating a plurality of print data based on single document data when said reception unit determines that it has received said instruction for generating the carbon copy.

7. The image forming system as claimed in claim 6, wherein
said transmission unit further transmits an instruction for adding a serial number,
said reception unit further receives said instruction for adding the serial number from said transmission unit, and
said image forming system further comprising:
a serial number adding unit for adding a serial number to at least one of said plurality of print data generated by said print data generation unit when said reception unit determines that it has received said instruction for adding the serial number.

8. The image forming system as claimed in claim 6, wherein
said transmission unit further transmits an instruction for fabricating said print data,
said reception unit further receives said instruction for fabricating said print data from said transmission unit, and
said image forming system further comprising:
a print data fabricating unit for executing at least one of fabrications of adding texts to at least one of said plurality of print data generated by said print data generation unit, masking a portion of said print data, and modifying said print data's background, when said reception unit determines that it has received said instruction for fabricating said print data.

9. The image forming system as claimed in claim 6, further comprising:
a print data for filing transmission unit for transmitting print data for carbon copy selected for filing from said plurality of print data using a network protocol to a server.

10. The image forming system as claimed in claim 9, further comprising:
a printing unit for printing on printing paper said print data other than said print data for carbon copy among said plurality of print data.

11. A printing instruction apparatus, comprising:
an input unit for entering an instruction for generating a carbon copy;
a print data generation unit for generating a plurality of print data based on single document data when said input unit determines that said instruction for generating said carbon copy is entered.

12. The printing instruction apparatus as claimed in claim 11 further comprising:
a serial number adding unit for adding a serial number to at least one of said plurality of print data generated by said print data generation unit.

13. The printing instruction apparatus as claimed in claim 11 further comprising:
a print data fabrication unit for at least one of fabrications of adding texts, masking a portion of said print data, or modifying said print data's background on at least one of said plurality of print data generated by said print data generation unit.

14. The printing instruction apparatus as claimed in claim 11 further comprising:
a print data for filing transmission unit for transmitting print data for carbon copy selected for filing from said plurality of print data using a network protocol to a server.

15. The printing instruction apparatus as claimed in claim 14 further comprising:
a print data for printing transmission unit for transmitting said print data other than said print data for carbon copy among said plurality of print data to a printing unit that prints print data.

16. A non-transitory computer readable storage medium stored with a program to be executed by either an image forming apparatus or a printing instruction apparatus, said program causing a computer to execute a process comprising:
(a) judging whether an instruction for generating a carbon copy exist or not; and
(b) generating a plurality of print data based on single document data when it is determined that said instruction for generating said carbon copy exists in said step (a).

17. The non-transitory computer readable storage medium as claimed in claim 16, wherein said process further comprising:
(c) adding a serial number to at least one of said plurality of print data generated in said step (b).

18. The non-transitory computer readable storage medium as claimed in claim 16, wherein said process further comprising:
(d) executing at least one of fabrications of adding texts, masking a portion of said print data, or modifying said print data's background on at least one of said plurality of print data generated in said step (b).

19. The non-transitory computer readable storage medium as claimed in claim 16, wherein said process further comprising:
(e) transmitting using a network protocol to a server print data for carbon copy selected for filing from said plurality of print data generated in said step (b).

20. The non-transitory computer readable storage medium as claimed in claim 19, wherein said process further comprising:
(f) printing on printing paper said print data other than said print data for carbon copy among said plurality of print data generated in said step (b).

21. An image forming method, comprising:
(a) judging whether an instruction for generating a carbon copy exist or not; and
(b) generating a plurality of print data based on single document data when it is determined that said instruction for generating said carbon copy exists in said step (a).

22. The image forming method as claimed in claim 21 further comprising:
(c) adding a serial number to at least one of said plurality of print data generated in said step (b).

23. The image forming method as claimed in claim 21 further comprising:
(d) executing at least one of fabrications of adding texts, masking a portion of said print data, or modifying said print data's background on at least one of said plurality of print data generated in said step (b).

24. The image forming method as claimed in claim 21 further comprising:
(e) transmitting using a network protocol to a server a print data for carbon copy selected for filing from said plurality of print data generated in said step (b).

25. The image forming method as claimed in claim 24 further comprising:
(f) printing on printing paper said print data other than said print data for carbon copy among said plurality of print data generated in said step (b).
